(19) United States
(12) Patent Application Publication
(10) Pub. No.: US 2007/0171526 A1
(43) Pub. Date: Jul. 26, 2007

(54) Stereographic positioning systems and methods

(75) Inventor: Eric Feron, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MASS INSTITUTE OF TECHNOLOGY (MIT), Cambridge, MA (US)

(21) Appl. No.: 11/340,329

(22) Filed: Jan. 26, 2006

(51) Int. Cl. G02B 27/22

(52) U.S. Cl. 359/470

(57) ABSTRACT

Methods and systems for determining position relative to a stereographic pattern generator including capturing an image of a stereographic pattern from a known stereographic pattern generator with a viewer. The location of portion of the stereographic pattern is determined relative to the stereographic pattern generator is then determined with a processor. The location information is used to find the orientation of the viewer relative to the pattern generator.

### BACKGROUND OF THE INVENTION

The invention relates generally to methods and apparatus for positioning or determining the position of an object by optical analysis.

Determining the position of an object relative to an other object (relative position) and/or the position of an object in generally (global position) has utility in a variety of areas. For example, the relative and global position of a vehicle is important for tracking and controlling the movement robots or other vehicles in factories and warehouses. Conventional systems often use beacons, radar, LIDAR techniques and global positioning satellite (GPS) technology as a means for determining position.

In particular, GPS systems find a position by triangulation from satellites. A group of satellites provide radio signals which are received by a receiver and used to measure the distance between the receiver and the satellites based on the travel time of the radio signals. The location of the receiver is calculated using the distance information and the position of the satellites in space. After correcting for errors such as delays caused by the atmosphere, GPS systems can provide positioning data within a few meters.

Unfortunately, GPS technology has certain limitations. One of the difficulties with GPS systems is that they rely on receiving signals from satellites position in orbit. Obstructions can diminish, disrupt or even block the signals. For example, when a GPS unit is positioned in the shadow of a large building the number of satellite signals can be reduced, or even worse, the surrounding structures can completely block all satellite signals. Natural phenomenon, such as cloud cover and charged particles in the ionosphere can also reduce the effectiveness of GPS systems. In addition, some positioning tasks require greater accuracy than GPS technology can provide.

Other positioning systems, which use local radio beacons, lasers, and/or radar can overcome these drawbacks. Unfortunately, these systems rely on specialized and costly apparatus, and may also require excessive synchronization and calibration.

As a result, there is a need for a simple and robust local positioning system which does not rely on orbiting satellites or local radio beacons, and which can provide increased positioning accuracy when needed.

### SUMMARY OF THE INVENTION

The present invention provides object positioning and attitude estimation systems based on an reference source, e.g., a stereographic pattern generator which generates a stereographic pattern. The invention further includes a viewer, mountable on an object, for capturing an image of the stereographic pattern. A processor can analyze the detected pattern and, based thereon, the orientation of the object relative to a reference location is determined.

In one embodiment, a system includes a stereographic pattern generator associated with a reference location and capable of generating a stereographic pattern. The system further includes a viewer mountable on an object for capturing an image of the pattern generated by the stereographic device and a processor in communication with the viewer for analyzing the image. Based on the analyzed image, the system can determine the orientation of the viewer relative to the pattern generator.

In one aspect, the stereographic pattern generator provides a stereographic pattern loci that varies in location depending on the position of the viewer. The position of the loci on the pattern generator can be used to determine the viewing angle of the viewer. In one embodiment, the position of the loci is linearly related to the viewing angle of the viewer.

In another aspect, the system includes two stereographic devices associated with the reference location. For example, the first stereographic device can be used to determine the viewing angle of the viewer in a first plane and the second stereographic device can be used to determine the viewing angle of the viewer in a second plane.

In yet another aspect, the stereographic device includes a lens assembly and a base card positioned behind the lens assembly. The base card can include a pattern that provides a stereographic pattern when viewed through the lens assembly. The lens assembly can include series of elongate lenses extending parallel to a longitudinal axis of the lens assembly. In one aspect, the base card includes a linear pattern that extends at an angle φ with respect to the longitudinal axis of lens assembly.

In another embodiment, a method of determining position relative to a stereographic device is provided. The method can include the steps of capturing an image of a stereographic pattern from a known stereographic device with a viewer and finding the location of a pattern loci relative to the stereographic device. Based on the position of the pattern loci, the relative orientation of the stereographic device with respect to the viewer can be determined.

### BRIEF DESCRIPTION OF THE DRAWINGS

The invention will be more fully understood from the following detailed description taken in conjunction with the accompanying drawings:

FIG. 1 is a schematic illustration of a system according to one embodiment of the invention;

FIG. 2A is a top view of one embodiment of a stereographic device described herein;

FIG. 2B is a side view of the stereographic device of FIG. 2A;

FIG. 3 is a top view of another embodiment of a stereographic device described herein;

FIG. 4 is a top view of one embodiment of a pattern used with the stereographic device described herein;

FIG. 5 is a top view of a stereographic device used with the pattern of FIG. 4;

FIG. 6 is top view of yet another embodiment of a stereographic device described herein; and

FIG. 7 is a top view of two orthogonal stereographic devices.

### DETAILED DESCRIPTION OF THE INVENTION

The present invention provides positioning systems and methods for determining a position in space, such as the location of an object. The system preferably includes a stereographic pattern generator, a viewer for capturing an image of the stereographic pattern, and a processor for determining orientation based on the information gathered by the viewer. The processor can derive position data based on the orientation of the viewer with respect to the stereographic pattern generator.

Unlike prior art positioning systems which rely on signals from distant transmitters, the present invention allows a user to determine position with only a stereographic pattern generator, a viewer, and a processor. For example, the system can be used inside a laboratory or warehouse where GPS measurements would be unavailable because the buildings block satellite signals. In addition, the system is easy to set up, can provide highly accurate positioning data, is inexpensive to operate, and is insensitive to electromagnetic interference. The present invention therefore provides a simple and robust positioning system that can assist with navigating, docking, tracking, measuring, and a variety of other positioning functions.

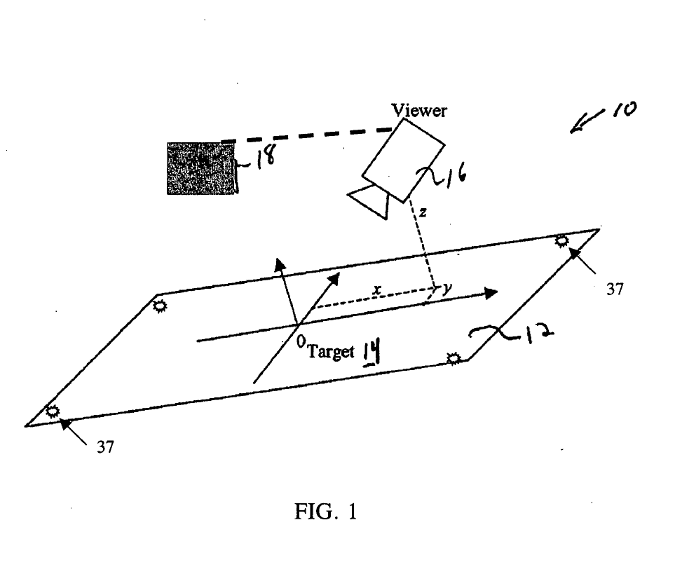

FIG. 1 illustrates one embodiment of a system 10 that includes a stereographic pattern generator 12 positioned on target 14 and a viewer 16 adapted to collect a digital image of a produced by pattern generator 12. System 10 can also include a processor 18 that is in communication with the viewer. Processor 18 can be housed with, or separately from viewer 16, and can communicate with viewer 16 in a variety of ways, such as for example, wirelessly.

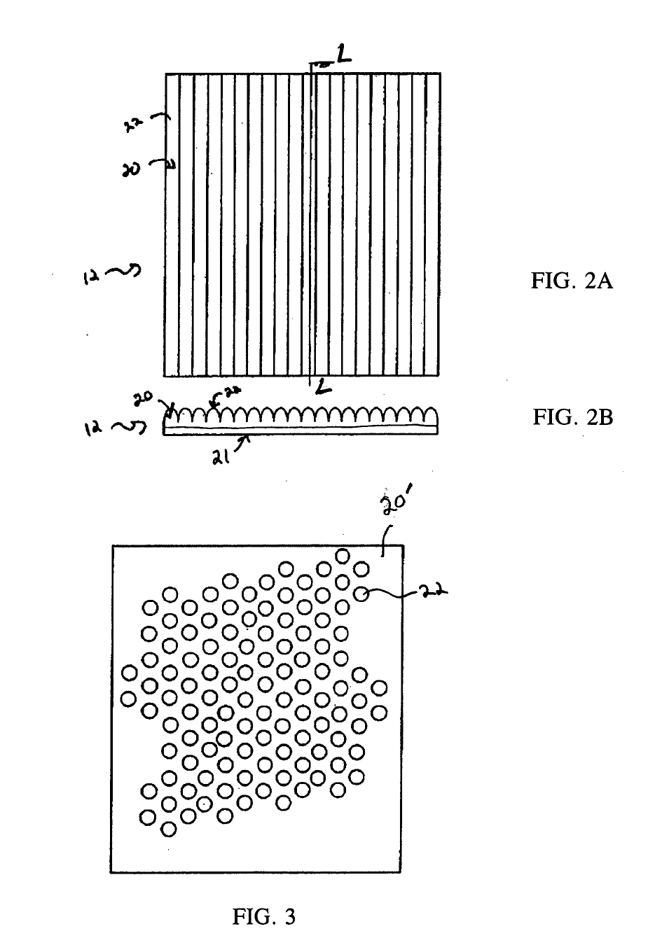

Stereographic pattern generator 12 can include a variety of pattern generators that provide a pattern that changes depending on the relative location of viewer 16. Preferably, pattern generator 12 is an autostereoscopic pattern generator. FIGS. 2A and 2B illustrate one such pattern generator that include a lens assembly 20 and a pattern 21. In one aspect, lens assembly 20 can include a sheet of elongate lenses 22 that extend parallel a longitudinal axis L of the pattern generator.

One skilled in the art will appreciate that lens assembly 20 can have a variety of alternative configurations and that the shape and size of the individual lenses can be varied depending on the intended use of system 10. For example, FIG. 3 illustrates a lens assembly 20′ that includes a series of closely spaced, circularly shaped lenses. A person skilled in the art will appreciate that lenses can have a variety of shapes such as, for example, rectangular, circular, triangular, and/or irregular.

Beneath lens assembly 20, pattern generator 12 can include a pattern 21 that will produce a stereographic pattern when viewed through lens assembly 20. For example, pattern 21 can be a printed pattern positioned on a base card disposed beneath lens assembly 20. In addition, or alternatively, pattern 21 can be positioned on a lower surface of lens assembly 20. For example, pattern 21 can be etched, printed, or otherwise formed on lens assembly 20.

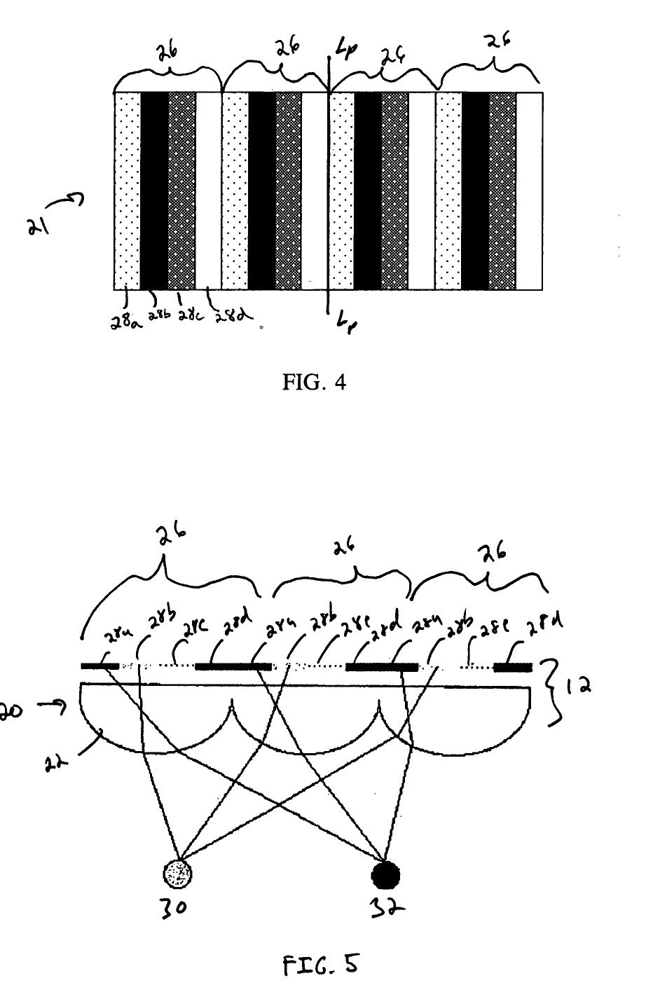

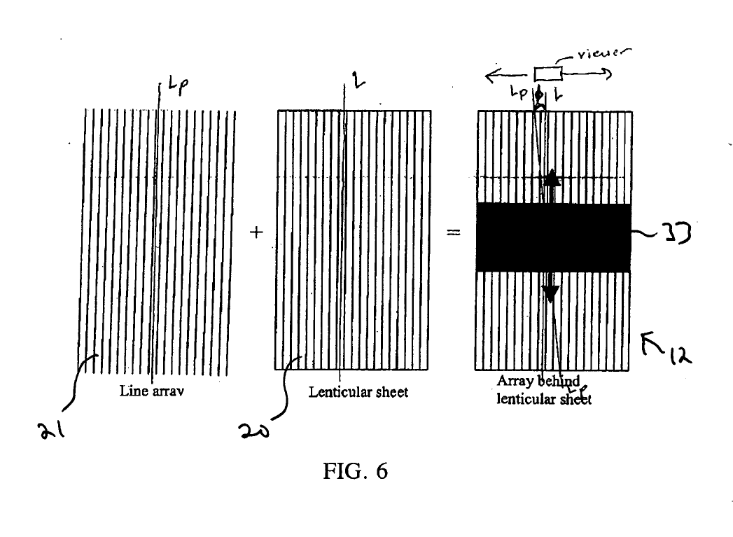

In one aspect, pattern 21 consists of a series of repeating images. For example, FIG. 4 illustrates one exemplary pattern 21 that includes a series of elongate images extending parallel to a longitudinal axis Lₚ of the pattern generator. In one aspect, pattern generator 12 is adapted such that the lenses 22 of lens assembly 20 are each associated with a portion of pattern 21. For example, pattern 21 can have a series of segments 26, each segment corresponding to one of the elongate lenses 22. Each segment can be further broken down into slices 28a, 28b, 28c, 28d. Depending on the position of the viewer, the lenses will focus on one of the slices 28a, 28b, 28c, 28d in the pattern segment associated with the lens. As the viewer changes position, the lenses will focus on a different slices of pattern segment 26.

FIG. 5 illustrates this concept. The pattern 21 includes segments 26 and four distinct pattern slices 28a, 28b, 28c, 28d within each segment. The lenses 22 of lens assembly 20 are configured such that from first position 30, a viewer will see pattern slice 28b. If the viewer moves to a second position 32, the viewer will see pattern slices 28a. One skilled in the art will appreciate that the number, spacing, and location of segments 26 and slices 28 will depend on the lenses 22 of lens assembly 20 and the particular application.

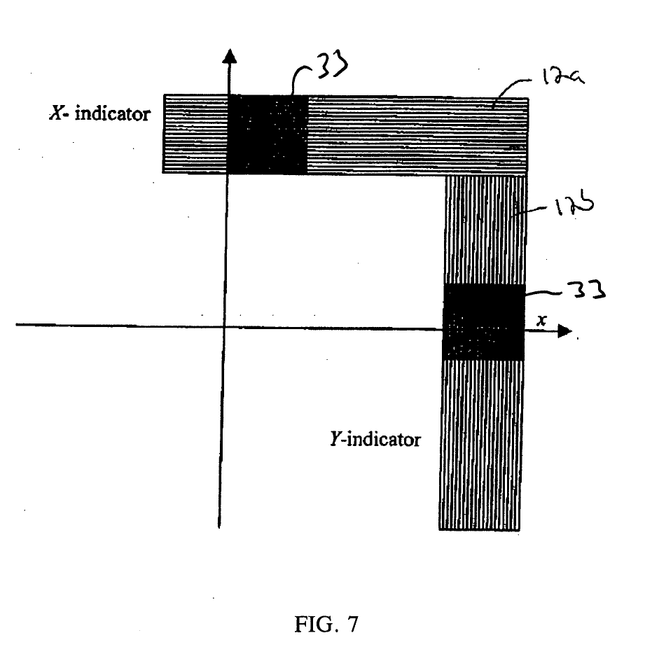

In one embodiment, as mentioned above, pattern 21 is configured such that slices 28 extend parallel to a longitudinal Lₚ axis of pattern 21 that is collinear to the longitudinal axis L of the lens assembly. In an alternative embodiment, slices 28 and/or longitudinal axis Lₚ are positioned at an angle (e.g., angle φ discussed below) with respect to the longitudinal axis L of lens assembly 20. FIG. 6 illustrates one such pattern generator that includes a pattern 21 consisting of a series of parallel lines and a lens assembly that includes parallel lenses 22. However, when combined, pattern 21 and lens assembly 20 are positioned such that there is an offsetting angle (angle φ) between the longitudinal axis Lₚ of the pattern and the longitudinal axis L of the lens assembly. As a result, the pattern generator 12 shows a stereographic image having a pattern loci 33 (i.e., the darkened area) that shifts longitudinally as the viewer moves transversely. The loci is created by the lenses focusing on the lines of pattern 21, and the area where stereographic image is not darkened is created by the lenses focusing on the portion of pattern 21 between the lines.

System 10 can use the location of loci 33 (i.e., darkened area) to determine the relative angle between the viewer and the patterns generator. For example, the viewer can capture an image of pattern generator 12 and based on the longitudinal position of the loci, a processor can determine the transverse angle at which the viewer is viewing the pattern generator.

In one embodiment, the offset between pattern 21 and lens assembly 20 is defined as an angle φ and the angle between the pattern generator 12 (or target 14) and the view is defined as θ. The center of the loci is then positioned along the longitudinal direction of the pattern generator at a position x. The position x is related to the viewing angle θ based on the equation
x=d tan Θ/sin Φ Equation 1

Where the term d is a characteristic length the lens assembly. Thus for small θ and small φ the equation becomes
x≅d*Θ/Φ Equation 2

Equation 2 defines a quasi linear relationship between the observed position of the loci on the pattern generator and the viewing angle of the viewer. This constitutes a considerable improvement with respect to having to monitor a single flat target where the visual changes of the target's appearance are square functions of the target orientation. As used herein, the term “linear” refers to relationships that are exactly linear, as well as, generally or quasi linear in nature.

In addition, as shown by Equation 2, the smaller the angle φ, the more sensitive system 10. Thus, the pattern generator 12 and system 10 can be easily adjusted depending on the required sensitivity.

The characteristics of the stereographic pattern produced by pattern generator 12 depend on the characteristics of the lenses 22 and the pattern 21. For example, if angle φ is small enough, pattern generator will not demonstrate any periodicity. Thus as a viewer changes angles from one extreme to the other, a single loci will travel one cycle along the longitudinal axis of the pattern generator. Alternatively, if the angle φ is larger, then the pattern generator will include more than one loci. For example, as the viewer changes its viewing angle, multiple loci will travel along the length of the pattern generator. As a result, the angle will be known up to an integer ambiguity.

Where pattern generator 12 exhibits periodicity, the actual viewing angle can be determined in a variety of ways, such as, for example, an algorithm for eliminating nonsensical or unlikely choices. For example, standard maximum likelihood estimation algorithms can be used to lift the integer ambiguity and obtain precise positioning data. The idea is to combine high-accuracy (up to an integer ambiguity), relative position information provided by the pattern generator with low-accuracy, absolute position information provided by a standard position estimation algorithm using the geometrical features of the interference pattern generator.

The periodicity of the pattern generator 12 (if present) are preferably matched to the scale and accuracy of the desired measurement. For measuring positions over a large area or where accuracy is less of a concern, a larger periodicity is preferred. Conversely, a smaller periodicity is preferred for smaller areas or for increased accuracy. In one embodiment, two pattern generators can be used to produce patterns having a large and a small period.

While system 10 is primary described with respect to a pattern generator having a pattern composed of parallel lines and parallel lenses, one skilled in the art will appreciate that a variety of other stereographic pattern generators could be used. In addition, the pattern, the lenses, the angle φ, and/or the length (and/or shape) of the lens assembly can be varied depending on the intended use of system 10.

The pattern generator of FIG. 6 generates a one-dimensional pattern. Such one-dimensional systems are useful where the height of viewer/object is known and/or the object is operating on a flat surface (such as a warehouse floor). FIG. 7 illustrates yet another configuration of system 10 in which two pattern generators are used. The pattern generators of FIG. 7 are particularly useful in obtaining two dimensional position information. The first pattern generator 12a can be used to determine an angle in a first plane (e.g., the x-dimension) and the second pattern generator 12b can be used to determine an angle in a second plane (e.g., they y-dimension). By calculating the viewer's angle with respect to both the pattern generator 12a and pattern generator 12b, location information in two dimensions can be determined.

If a users wishes to determine location information in three-dimensions, an additional pattern generator can be used. For example, a third (or forth, more) pattern generator spaced from the first and second pattern generators can be used to determine a position in three dimensions (not shown). In one aspect, the additional pattern generator(s) is positioned in a different plane from the first and second pattern generators. Alternatively, or additionally, standard projective geometric techniques can provide additional location information. For example, the apparent size and shape of the stereographic device, its known (actual) size, and/or the viewing angles determined from the pattern generator(s) can be used to find location in a third dimension.

One skilled in the art will appreciate that the pattern generator 12, as illustrated in any of the above referenced figures, can be scaled according to the intended use. For measuring very small movements, such as the movement of a person's skin in response to their heartbeat, the pattern generator might cover an area smaller than a postage stamp. In other applications, such as assisting with docking of large vessels (e.g., cargo ships) the pattern generator could cover an area hundreds of feet across.

In certain embodiments, pattern generator 12 can be illuminated by ambient light alone. Alternatively, to assist with capturing an image, pattern generator 12 can be illuminated. One skilled in the art will appreciate that the pattern of pattern generator(s) 12 can be created with a variety of different types of electromagnetic radiation. For example, the light chosen for illumination may be of any wavelength which can be acquired by the viewer, including both visible and non-visible light. Exemplary alternative sources of radiation include visible, ultraviolet and infrared light. More generally, any electromagnetic radiation source capable of generating a stereographic pattern can be employed.

To assist with calculating position data, the pattern generator can include a variety of markers. For example, as shown in FIG. 1, marker 37 can be placed at one or more corners of the pattern generator; a preferred marker is a light having a distinct color or wavelength. The processor can then use the marker to determine the pattern generator orientation, e.g., which side of the pattern generator image captured by the viewer is the top side. Where the viewer may have some trouble distinguishing the pattern generator from a cluttered background, the marker can also help the viewer locate the stereographic pattern. A person skilled in the art will appreciate that the pattern generator can also be distinguished base on its shape, illumination, color, other characteristics, and/or combinations thereof.

The image of the stereographic pattern is preferably captured by a viewer 16 capable of acquiring data representing an image containing the stereographic pattern and supplying the data to a processor 18. In one embodiment, the viewer 16 is a camera which can acquire images, preferably digital, of the scene containing the pattern generator. The camera preferably has a large enough angular aperture to detect the pattern generator (target) over a large range of locations, and to has enough resolution to detect the shape of the target. The choice of camera will depend on the wavelength of the radiation which creates the interference fringes. Exemplary cameras include IR cameras and most standard, commercially available, video cameras.

The processor 18 uses data from the viewer 16 to process the image from the pattern generator 12 and to obtain position data. The processor 18 preferably is capable of performing a variety of computations based on information from the viewer and information about the characteristics of the interference pattern generator. The calculations can include input from the viewer as well as stored information and/or information entered by a user. A person of skill in the art will appreciate that the processor can be a dedicated microprocessor or chip set or a general purpose computer incorporated into the object whose location is to be determined, or a similar but remote dedicated microprocessor or general purpose computer linked to viewer by wireless telemetry. Further information on computations and methods for resolving ambiguities can be found in commonly owned, copending U.S. application Ser. No. 10/709,506, hereby incorporated by reference in its entirety.

Although the above examples are generally given in terms of finding the position of the viewer 16, the processor 18 can also calculate a global position and/or a relative position of a secondary point in space or object. For example, the viewer could be mounted on an object, such as a vehicle, and the processor could be used to determine the position and/or orientation of the object. The position of the object can be calculated by the processor directly, or stepwise based on the relative position of the pattern generator to the viewer, and the viewer to the object.

As discussed above, in some cases the pattern generator will have a periodicity. In such cases, the method of determining orientation can utilize a feature extraction algorithm based on the geometrical features of the pattern generator to obtain a low-resolution estimate on the position and orientation using stored information concerning the geometry of the target, the characteristics of the viewer, and data from the viewer. Exemplary stored information can include the dimensions of the target, e.g., rectangular with given edge lengths, and minimal information about the camera, e.g., the angular aperture of the camera.

A person skilled in the art will also appreciate that the foregoing is only illustrative of the principles of the invention, and that various modifications can be made by those skilled in the art without departing from the scope and spirit of the invention. All references cited herein are expressly incorporated by reference in their entirety.

1. An object positioning and attitude estimation system, comprising:
at least one stereographic device associated with a reference location and capable of generating a stereographic pattern;
a viewer mountable on an object for capturing an image of the pattern generated by the stereographic device; and
a processor in communication with the viewer for analyzing the image and, based thereon, determining the orientation of the viewer relative to the reference location.

2. The system of claim 1, wherein the stereographic pattern provides a pattern loci that is a function of the viewing angle of the viewer.

3. The system of clam 2, wherein the function is a generally linear relationship.

4. The system of claim 1, wherein the system further comprises two stereographic devices associated with the reference location.

5. The system of claim 4, wherein each of the stereographic devices has a longitudinal axis, and the stereographic devices are positioned such that the longitudinal axes are generally perpendicular to one another

6. The system of claim 1, wherein the stereographic device includes a lens assembly and a base card positioned behind the lens assembly.

7. The system of claim 6, wherein the base card includes a pattern.

8. The system of claim 6, wherein the lens assembly comprises a series of elongate lenses extending parallel to a longitudinal axis of the lens assembly.

9. The system of claim 8, wherein the base card includes a linear pattern that extends at an angle φ with respect to the longitudinal axis of lens assembly.

10. The system of claim 1, wherein the stereographic device further comprises a light source.

11. The system of claim 1, wherein the system includes at least one optical marker to provide an estimate of distance and orientation.

12. The system of claim 11, wherein the optical marker defines a border around the pattern generator.

13. The system of claim 1, wherein the viewer comprises a camera.

14. The system of claim 1, wherein the processor comprises an image processor that is adapted to determine the relative location of the stereographic device based on the stereographic pattern produced by the stereographic device.

15. The system of claim 1, wherein the stereographic device is an autostereoscopic device.

16. A method of determining position relative to a stereographic device, comprising:
capturing an image of a stereographic pattern from a known stereographic device with a viewer;
finding the location of a pattern loci relative to the stereographic device;
determining a relative orientation, using a processor, of the stereographic device with respect to the viewer based on the location of the pattern loci.

17. The system of claim 16, wherein the location of the pattern loci a function of the viewing angle of the viewer.

18. The method of claim 17, wherein the stereographic device includes a lens assembly having a longitudinal axis L and a series of lenses extending parallel to the longitudinal axis.

19. The method of claim 18, wherein the stereographic device includes a linear pattern extending parallel to an axis L_{p.}

20. The method of claim 19, wherein the longitudinal axis L of the lens assembly and the axis Lₚ of the pattern are positioned at an angle φ relative to one another.

21. The method of claim 20, wherein the pattern loci is at a location x on the stereographic device and the relative angle of the viewer with respect to the stereographic device is at an angle θ.

22. The method of claim 21, wherein the angle θ is determined based on an equation x =d tan Θ/sin Φ, where d is a characteristic length of the stereographic device.

23. The method of claim 21, wherein the angle θ is determined based on an equation x ≅d Θ/Φ, where d is a characteristic length of the stereographic device.
